(19) United States
(12) Patent Application Publication
(10) Pub. No.: US 2008/0230041 A1
(43) Pub. Date: Sep. 25, 2008

(54) High efficiency alcohol fuel engine

(76) Inventors: Matthew J. Brusslar, South Lyon, MI (US); Charles L. Gray, Pinckney, MI (US); David James Haugen, Ann Arbor, MI (US)

Correspondence Address: David Read;US EPA, NVFEL, 2565 Plymouth Rd., Ann Arbor, MI, 48105, US

(21) Appl. No.: 12/077,378

(22) Filed: Mar. 19, 2008

Related U.S. Application Data
(60) Provisional application No. 60/919,251, filed on Mar. 21, 2007.

(51) Int. Cl. F02B 13/00

(52) U.S. Cl. 123/575; 60/299; 123/568.11

(57) ABSTRACT

In an internal combustion engine adapted to combust alcohol blend fuels (i.e., fuels containing greater than 20% alcohol by volume), a dilute combustion mixture (e.g., with substantial EGR), intake air cooling, and latent cooling caused by vaporization of the alcohol fuel, are used together with a compact combustion chamber (in which the distance between the spark plug tip and furthest point of the combustion chamber is less than one-half the cylinder bore diameter) and controlled spark retardation to enable the use of a high compression ratio (greater than 15:1), for improved efficiency without triggering auto-ignition. Thermal brake efficiency significantly exceeds that for conventional gasoline engines, thereby improving the potential cost-effectiveness of alcohol fuels. Stoichiometric operation is used for optimal emissions control.

### RELATED APPLICATIONS

This application claims priority from U.S. provisional application 60/919,251, “High Efficiency Alcohol Fuel Engine,” filed Mar. 21, 2007.

### FIELD OF THE INVENTION

This invention relates to internal combustion engines, particularly those designed for use with high octane alcohol or alcohol blend fuels, including ethanol and methanol.

### BACKGROUND AND DESCRIPTION OF THE PRIOR ART

Alcohol fuels, principally methanol and ethanol, have the potential to displace a substantial portion of petroleum consumption, used either neat or in blends with petroleum fuels. Brazil, for example, predominantly uses ethanol for transportation fuel in place of gasoline. Lacking in the art, however, is an internal combustion engine that operates with high efficiency with alcohol or alcohol blend fuels. Instead, current flex-fuel vehicles that use alcohol fuels generally operate with alcohol fuels at efficiency levels only slightly higher than, or even less than, when using gasoline as the fuel. Because alcohol fuels also have a lower volumetric energy content than conventional gasoline, the resulting poor mileage obtained with alcohol fuels (e.g., as much as 30% fewer miles per gallon for E85 fuel compared with gasoline) undermines the attractiveness of such fuels to the consumer. For purposes of this application, the terms “alcohol fuel” and/or “alcohol blend fuels” shall refer to fuels containing greater than 20% alcohol (e.g., ethanol or methanol) by volume.

An internal combustion engine that operates at high efficiency with alcohol fuels would improve the potential for alcohol fuels to reduce petroleum consumption. In addition, an internal combustion engine that cost-effectively obtains comparable, or greater, miles per gallon with alcohol fuels than is obtained by a comparable gasoline engine would support the goal of using alcohol fuels to displace gasoline as a primary transportation fuel.

Applicant has previously disclosed a high efficiency port injected internal combustion engine for use with alcohol fuels, the disclosures on which are incorporated herein by reference in their entirety. See Matthew Brusstar, et. al., “High Efficiency and Low Emissions from a Port-Injected Engine with Neat Alcohol Fuels,” at SAE 2002-0102743; see also Matthew Brusstar and Marco Bakenhus, “Economical, High-Efficiency Engine Technologies for Alcohol Fuels,” presented at ISAF XV International Symposium on Alcohol Fuels, Sep. 28, 2005. A high compression ratio engine combusting methanol or ethanol fuel is further disclosed in commonly-assigned U.S. Pat. No. 6,651,432 (“Controlled Temperature Combustion Engine”), which is also incorporated herein by reference for explanation of the principles described herein.

U.S. Pat. No. 4,742,804 to Suzuki recognizes some advantages of alcohol fuels for improved efficiency, but uses lean combustion and multiple spark plugs and combustion cavities per cylinder, which would therefore create high engine-out harmful emissions, along with increased manufacturing and emission-control costs.

Saab sells flex-fuel vehicles with a powertrain referred to as “BioPower” which increases the compression ratio to 11:1 to improve efficiency in combusting alcohol fuel.

### OBJECT OF THE INVENTION

It is an object of the present invention to provide an internal combustion engine that operates at high efficiency with alcohol or alcohol blend fuels.

It is a further object to provide an embodiment of the present invention that would enable alcohol fuel blends to be a more economically viable alternative to gasoline as a preferred transportation fuel.

### SUMMARY OF THE INVENTION

An internal combustion engine is provided for highly efficient combustion of alcohol fuels. A high compression ratio (e.g., greater than about 15:1, and preferably between 17:1 and 19.5:1) is utilized. Auto-ignition is avoided, despite the high compression ratio, through the use of a dilute combustion mixture with reduced intake oxygen concentration (e.g., using substantial EGR), reduction of the final compression temperature (T₂) of the fuel/air mixture (through cooling of the intake air and latent cooling caused by vaporization of the alcohol fuel, e.g., during the compression stroke), through the use of a compact combustion chamber to reduce the distance of flame travel, and by retarding the spark timing sufficiently to avoid knocking while having sufficient spark authority to maintain efficient combustion phasing. Stoichiometric operation is used for desired emissions control.

### BRIEF DESCRIPTION OF THE DRAWINGS

FIG. 1 presents a schematic view of an internal combustion engine system of the present invention.

FIG. 2 is a cross-sectional view of a compact combustion chamber of the present invention.

FIG. 3 is cross-sectional view of a second compact combustion chamber of the present invention.

FIG. 4 is a sample engine efficiency map for the internal combustion engine system of the present invention, at a compression ratio of 19.5:1, using neat methanol.

FIG. 5 is a second sample engine efficiency map for the internal combustion engine system of the present invention, using E85 fuel.

FIG. 6 is a third sample engine efficiency map for the internal combustion engine system of the present invention, using E30 fuel (i.e., 30% ethanol, 70% gasoline).

### DETAILED DESCRIPTION OF THE INVENTION

Prior to discussion of the figures and of the preferred apparatus of the present invention, certain factors and relationships in the technology will first be discussed.

The temperature at the end of the compression stroke (T₂) in a fixed compression ratio engine is a critical determining factor, along with the pressure, for the burn rate and time to autoignition, and hence the tendency to knock. The tendency to knock is primarily a function of the laminar burn velocity (laminar flame speed) and the turbulence of the charge-air during the combustion/burn event. The laminar burning velocity (SL) in a spark ignition engine is believed to relate to pressure (p) and temperature (T) generally according to the relationship SL˜T^{a}/p^{b} where a is around 2 and b is small (around 0.15 to 0.2). Given this relationship, it may be seen that as the temperature increases, the burn velocity increases. On the other hand, when the pressure is increased, the burn velocity decreases.

The time to autoignition (τ) likewise is believed to relate to the octane number (ON), absolute temperature (K), and pressure (p, expressed in bar-abs) according to the general relationship τ˜((ON)^{m}/pⁿ)e^{(B/T)} where m is about 3.4, n is about 1.7, and B is about 3800. Given this relationship, it may be seen that as the temperature increases, the time to autoignition decreases, and that as the pressure increases, the time to autoignition also decreases.

Generally, T₂ relates to the pressure in the cylinder in that higher pressures portend higher temperatures, and vice versa. A lower T₂ will give a slightly lower peak pressure at the end of the compression stroke. As indicated above, both lower temperature and lower pressure increase the time to autoignition. Conversely, as T₂ and the corresponding compression pressure rise, the autoignition time decreases accordingly, but at an amount much higher than the decrease in combustion time. As a result, increasing T₂ raises the tendency for knock.

For a gas undergoing compression (without a change of phase), T₂ is related to T₁ (temperature of the intake air) according to the relationship T₂/T₁=CR^{(1/k-1)} where CR is the compression ratio. So, assuming the compression ratio is fixed, T₂ can be controlled by controlling T₁ such as by cooling the intake air from the compressor with a cooling device such as an intercooler, increasing the total charge mass through supercharging or turbocharging to reduce the rise in T₂, reducing trapped hot exhaust gas residuals by raising the boost and thereby increasing the scavenging efficiency, or using the latent heat of vaporization of the fuel to cool the charge. Alcohol fuels have a latent heat of vaporization per unit energy that relates almost linearly with the oxygen mass fraction of the fuel, so lower molecular weight alcohols (such as methanol, then ethanol) have high latent heat values. Water also has a high latent heat of vaporization, and may be combined with the fuel (or port or direct injected) for additional cooling effect.

The latent heat cooling effect may be further maximized by reducing the fraction of the latent heat of vaporization lost to wall wetting in the intake ports and combustion chamber walls. This may be done, for example, by using greater charge mass momentum to entrain the fuel spray into the cylinder, better spray breakup/atomization over the intake valves into the cylinder, proper control of spray injection timing, using insulated intake ports and/or intake ports of minimal length, or by using a direct fuel injection strategy that brings about a well-mixed homogenous charge for combustion.

Other factors that mitigate the tendency for knock in a spark ignited alcohol fuel engine include (i) using a higher charge mass, for the reasons stated above and because the increased turbulence intensity in the combustion chamber is believed to raise the flame speed approximately according to a ⅔-power relationship, (ii) using a fuel with a high fuel mass per unit energy (especially methanol), thereby raising the total charge mass, and perhaps (iii) using a higher swirl ratio to increase heat transfer during the early stage of the intake charge, thereby reducing hot spot formation, and to give greater turbulence intensity in the combustion chamber, thereby giving higher burn rates.

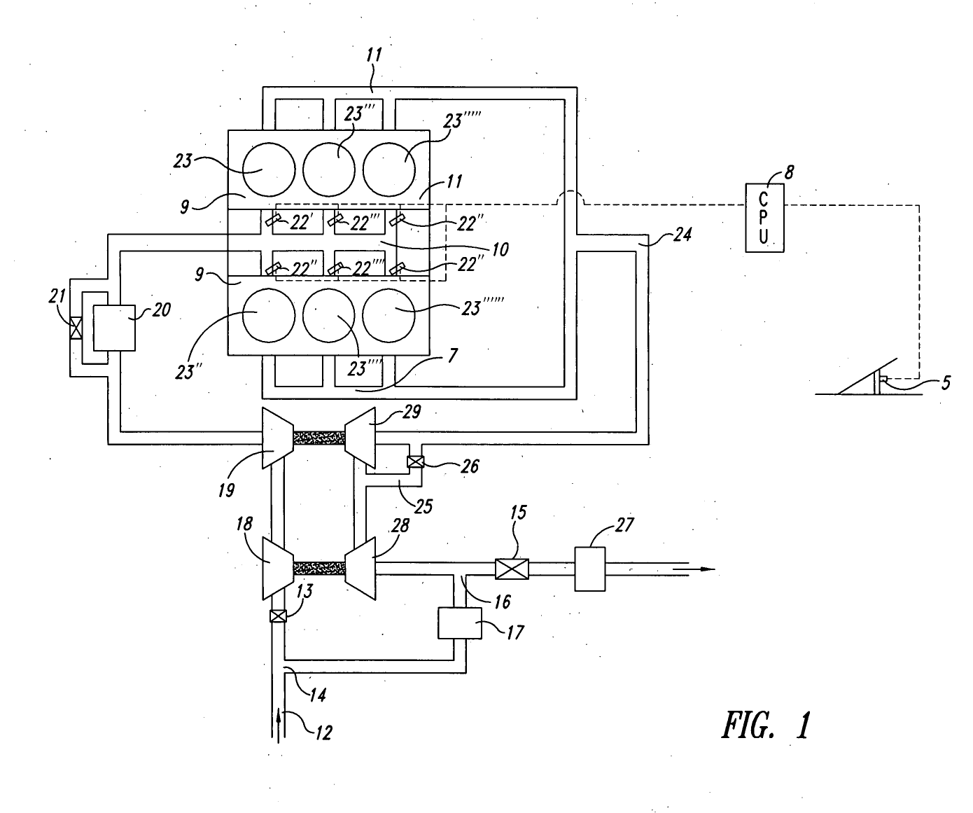

Having discussed these general principles above, FIG. 1 now portrays a preferred embodiment for a combustion system for multicylinder engine 11 in accordance with the present invention. Intake air enters the intake system at port 12 and flows through optional throttling valve 13. Exhaust gas is mixed with the intake air (forming the charge-air mixture) at port 14 (preferably positioned as part of a low pressure EGR loop, although a cooled high pressure EGR loop could be used instead or in addition to the low pressure EGR loop), with EGR control valve 15 in the exhaust line 24 creating an exhaust back pressure to force exhaust gas to flow through port 16, through optional cooler 17 to port 14. Alternatively, the optional cooler 17 may be placed upstream of the EGR control valve 15, thereby lowering the operating temperature of the EGR control valve. The charge-air then flows through low pressure compressor 18 and high pressure compressor 19, which may be driven respectively by turbine/motors 28 and 29. Alternatively, a single stage turbocharging system or other boost system may be used in place of the multi-stage turbocharging system shown, as will be known in the art.

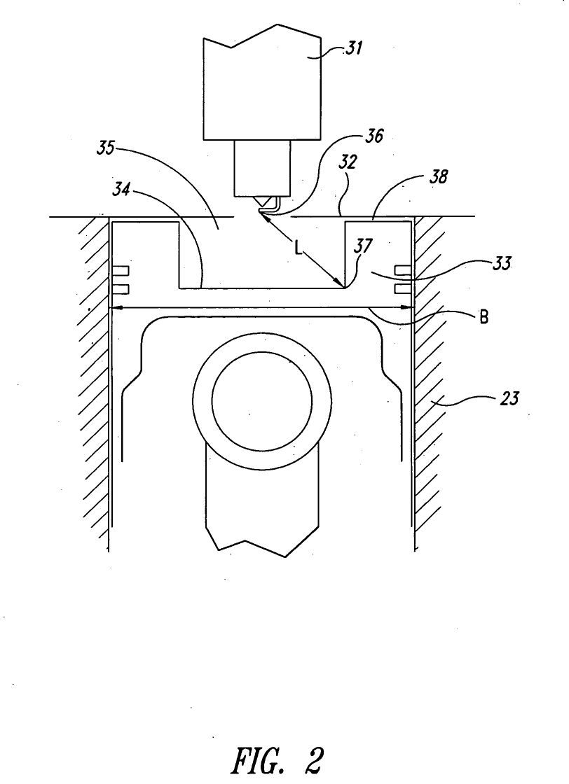

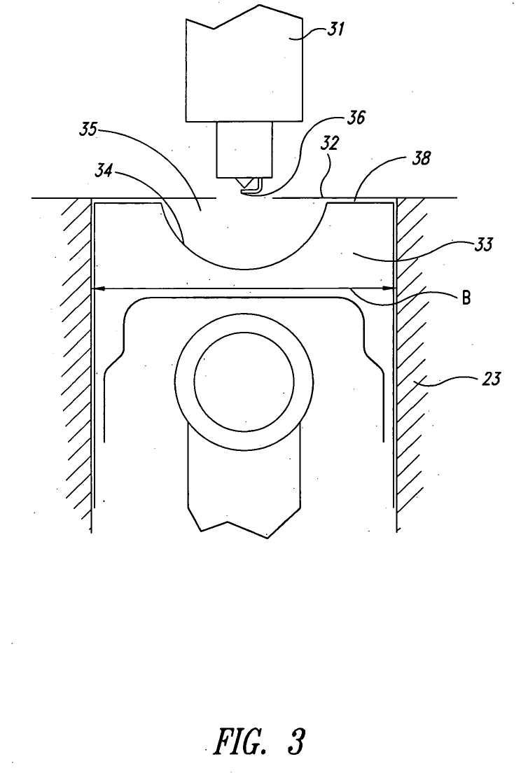

Continuing with FIG. 1, a portion or all of the charge-air may flow through cooler 20 (preferably an air-to-air cooler, but alternatively a water-to-air or other cooling device may be used) for temperature control, or through a bypass path, as controlled by bypass valve 21. The charge-air then enters the intake manifold 10 into engine block 9 where port fuel injectors 22′, 22″, 22′″, etc provide fuel for combustion. Alternatively, early direct injection of fuel may be used in place of or in conjunction with port fuel injection if desired, where the direct injected fuel provides more precise control of the evaporative cooling effect of the fuel on the charge mass to manage T₂. Injection of fuel is controlled through signals from controller 8. Engine 11 comprises a plurality of combustion cylinders 23′, 23″, 23′″, etc formed in the engine block 9, as known in the art. The charge-air and fuel enter a combustion chamber 35 (shown in FIGS. 2-3) of each respective cylinder 23′, 23″, 23′″, etc through intake valve(s) (not shown). Combustion occurs and the exhaust gases exit each combustion chamber through exhaust valve(s) (not shown) into the exhaust manifold 7 and to exhaust line 24.

Exhaust gas flows through exhaust line 24 through high pressure turbine/motor 29 (or bypass line 25 controlled by pressure relief valve 26) and low pressure turbine 28. Catalyst 27 is provided to clean the exhaust gas before exiting to ambient air. Catalyst 27 is preferably a three-way catalyst, and may be located before or after turbines 28 and 29 in the exhaust line.

Various sensors may also be provided in locations throughout the internal combustion engine system of FIG. 1, to detect information useful for system control, including but not limited to oxygen concentrations, air temperatures, cylinder pressures, etc. This sensed information may be provided, for example, to controller 8 for determinations in controlling fuel injection for the engine and appropriate levels of intake charge mass, dilution and temperature.

FIG. 2 additionally provides a cross-sectional view of a preferred compact combustion chamber of the present invention, for use within each cylinder 23′-23ⁿ of engine 11 of the internal combustion engine system of FIG. 1.

Referring to FIG. 2, cylinder 23 within engine 11 contains therein a piston assembly 33 reciprocally mounted therein for travel between a bottom dead center position and top dead center position, as known in the art. Spark plug 31 (or alternatively a different high energy ignition source, such as plasma ignition) is positioned within cylinder head 32, here shown at or near the center of cylinder head 32, at one end of the cylinder 23. A combustion bowl 34 is also formed in a head of piston assembly 33, thereby also defining the boundaries of compact combustion chamber 35 together with the bottom face of cylinder head wall 32.

The combustion chamber 35 is preferably configured with a low surface to volume ratio and to provide enhanced turbulence and short burn duration. The compact combustion chambers used in the present invention are generally axisymmetric and semicircular or elliptical in cross-section. Chamber depth is generally limited, giving a flattened or somewhat rectangular shape to the bowl. In one embodiment of the invention, the major diameter of the combustion chamber is between 0.45-0.50 times the cylinder bore diameter (B), with satisfactory performance to 0.65 B.

The combustion chamber 35 is defined for the purposes of the present invention as “compact,” in that the furthest distance “L” from the tip 36 of the spark plug 31 to the furthest point 37 of the combustion chamber 35 is less than one-half the cylinder bore diameter B, whereas in a typical gasoline engine of the prior art the distance L would be one-half B or substantially greater than that. There is, therefore, some preference for a central positioning of the spark plug 31 in relation to the combustion chamber 35 in order to reduce the distance L that the combustion flame will travel in combustion (and thus the time to complete the combustion reaction). Further, the large-radius feature of the combustion chamber design also reduces the tendency for hot spot ignition or local surface ignition of the fuel.

For purposes of this application, the squish volume 38 is not considered or included as part of the combustion chamber 35 in the determination of the furthest point 37 in the combustion chamber 35. The squish volume 38 is preferably minimized in that, for example, turbulence in the combustion chamber is thereby increased, and heat transfer from the squish region into the chamber walls is enhanced, which increases burn velocity, lowers end gas temperature and further suppresses autoignition.

The combustion chamber is compact to reduce the distance L that the flame must travel in combustion. A shorter travel distance L for the flame in combustion reduces the time required for combustion of all the prepared fuel-air mixture, which thereby reduces the time before the flame front reaches the end gas location. If the flame front consumes the end gas before the characteristic induction time for autoignition passes, the autoignition process can be avoided. Reduction of the distance L further reduces the potential for hotspots that could result in premature combustion. The optimal distance L for the combustion chamber depends on the compression ratio utilized for the combustion. As one example, from their testing, applicants have found the preferred distance L for the combustion chamber dimensions to be approximately 0.3 times the cylinder bore diameter B when the engine operates at a compression ratio of about 16:1, with a range of 0.22 B to 0.35 B depending on geometric constraints on the available bowl depth, the clearance volume, and compression ratio. At a lower compression ratio (but still high compared to conventional gasoline combustion), such as 15:1, the value for L can increase to about one-half the cylinder bore diameter.

The particular combustion chamber design chosen, and the swirl ratio (e.g., 2.0 in one embodiment) on the inlet ports for the engine, are preferably also selected to reduce the tendency for engine knock, and are within the ability of one skilled in the art.

Since the time required for combustion is also dependent on engine speed, it will also be understood that at a different engine speed the value of L could be a little different but still result in the same quantity of time for combustion. Thus, for a variable compression ratio engine (e.g., such as a piston-in-piston variable compression ratio engine disclosed in commonly-owned U.S. Pat. No. 6,752,105), the depth of the combustion chamber could be adjusted to adjust L for a given engine speed if desired.

FIG. 3 presents an alternative embodiment of the compact combustion chamber of the present invention with a hemispherical or “shallow hemispherical” shaped combustion chamber. The elimination of even the rounded corners of FIG. 2 in the combustion bowl (which is preferably also deburred to provide a smooth, clean surface) further reduces the chance for trapped end gas and potential hot spots and auto-ignition.

Now, with respect to the internal combustion system and engine apparatus shown and described in FIGS. 1-3 above, it would be understood in the art that the high octane number for alcohol fuels (e.g., over 100) and higher autoignition temperatures of alcohol fuels compared to gasoline (e.g., alcohols are about 150 degrees Celsius higher) would allow for some ability to operate at higher compression ratios than gasoline without preignition, but not to the compression ratios (of 15:1 or higher) desired for the present invention. See, e.g., M. T. Overington, et. al, Gasoline Engine Combustion—Turbulence and the Combustion Chamber, SAE 810017 (1981), at 7-8.

To reach higher compression ratios and higher efficiencies for alcohol fuel engines, new methods of operation of the engine system are also needed. Therefore, a preferred method of operation of the system for improved efficiency will now be set forth, with four basic principles being to use (i) a high compression ratio and unthrottled (or minimally throttled) operation for high efficiency, (ii) turbocharging with moderate to higher levels of EGR (with maximum EGR levels of as much as 50% for neat alcohol fuels, but lower for fuel blends with less alcohol content), for greater charge density, extended load range and low NOx emissions, (iii) cooling of the intake air and latent cooling of the fuel/air mixture in vaporization of the fuel, and (iv) stoichiometric fueling, for highest power density and to allow use of conventional three-way catalyst technology.

One principle of the internal combustion engine of the present invention is to take advantage of the higher laminar flame speed of alcohol fuels in comparison to gasoline. The high laminar flame speed of the alcohol fuel allows the engine to be run unthrottled in most conditions for improved efficiency. This is in contrast to conventional gasoline spark ignition engines. In the preferred embodiment, throttling is needed, if at all, only for lower, near-idle loads, thus resulting in significant efficiency improvements.

Another principle of operation for the internal combustion engine of the present invention is to use turbocharging and high levels of exhaust gas recirculation (EGR). Indeed, instead of relying on lean operation to reduce the laminar flame speed when needed, engine operation is maintained at stoichiometry and high levels of EGR are instead used to modulate load. High EGR levels have been found to have some effect in suppressing knock at higher compression ratios. A variable geometry turbocharger and/or multi-stage turbocharging system (18, 28 and 19, 29 with reference to FIG. 1) is preferably employed to help maintain the engine's specific power despite the relatively high charge dilution with EGR.

Cooling of the intake air is also important, through intercooler(s) 20, and/or aftercoolers, to help maintain the air temperatures in the intake manifold cool (e.g., around 40 degrees Celsius in one embodiment) even at higher speeds and loads. Heat transfer in the intake ports and cylinder to the charge-air is also preferably reduced, such as by use of insulated intake ports. Direct or port water injection may also be used to further control T₁ and/or T₂.

However, cooling can be further extended by taking advantage of the latent heat (heat of vaporization) of alcohol fuels to bring about significant charge cooling in the compression stroke, in that the alcohol fuel absorbs a considerable amount of heat upon vaporizing in the compression stroke. Some vaporization of the fuel, and accompanying cooling, will also occur after fuel injection prior to intake in the port as well. The combination of latent heat cooling from the alcohol fuel during compression, together with the earlier cooling and control of the temperature of the intake charge-air taken into the cylinder allows for control of T₂. T₂ here refers to the final compression temperature of the charge-air near the end of the compression stroke leading into combustion. See commonly-assigned U.S. Pat. No. 6,651,432. The cooling described herein allows for an even higher compression ratio and longer autoignition delay (induction time), and reduces the compression work considerably, thereby also improving efficiency.

Also, with EGR, the charge mass can be adjusted over which the latent heat cooling is distributed, while holding fuel at stoichiometric conditions. Adding more boost and EGR at constant fuel can be used to hold exhaust oxygen concentration to zero.

Meanwhile, stoichiometric combustion of the alcohol fuel blends is important for reduction of emissions, for example in allowing use of a three-way catalyst 27 in exhaust aftertreatment for optimal emissions reduction.

A key aspect of the invention is that, through the principles and methods stated above, the flame speed in combustion (i.e., combustion burn speed) can be partially managed herein by balancing the fuel/air mixture temperature at the end of piston compression and the respective concentrations of the reactants (i.e., of fuel and oxygen in the fuel/air mixture) to provide a good combustion burn speed, but such as will not result in pre-ignition or auto-ignition at the high compression ratios utilized. In particular, reducing T₂ (through cooling of the intake air in addition to the latent heat cooling of alcohol fuels) and/or reducing the oxygen fraction of the fuel/charge-air mix (through exhaust gas recirculation as described above or in commonly-assigned U.S. Pat. Nos. 6,651,432 or 6,857,263 to manage reaction rates) can both help increase the autoignition delay of alcohol fuels to avoid auto-ignition.

Spark timing for the engine is preferably controlled to minimum advance for best torque and/or to barely avoid the onset of borderline knock in the end-gas, for highest efficiency. Spark timing may be controlled either open-loop or preferably with closed-loop feedback using any of various combustion parameters (e.g., related to burn rates, combustion phasing, or knock sensing).

For changes in load, in accordance with principles of commonly-owned U.S. Pat. No. 7,047,741 to Gray, changes in engine load are preferably obtained by first changing the mass of oxygen in the charge-air by changing the level of recirculated exhaust or boost level of the charge-air, and to then, in preferably closed loop fashion, adjust the fueling rate to change the engine load. However, in the present invention, controller 8 adjusts the fueling rate to also maintain stoichiometric operation. Further, and unlike conventional gasoline engines, operation in the present invention is generally unthrottled. Thus, the accelerator pedal does not directly change the fueling rate or charge-air throttling, and instead a pedal position sensor 5 senses the desired load change, to which the charge-air mass is adjusted to correspond to the desired load.

Further engine specifications for an embodiment of the invention are described in applicant's prior work (e.g, Matthew Brusstar, et. al., “High Efficiency and Low Emissions from a Port-Injected Engine with Neat Alcohol Fuels,” at SAE 2002-01-2743; Matthew Brusstar and Marco Bakenhus, “Economical, High-Efficiency Engine Technologies for Alcohol Fuels,” presented at ISAF XV International Symposium on Alcohol Fuels, Sep. 28, 2005), which are incorporated herein by reference.

As has been discussed above, through the use of the hardware and methods set forth above, a high compression ratio may be obtained. Preferred compression ratios are 15:1 or higher, with a compression ratio of about 16.5:1 more preferred, and a compression ratio of about 19.5:1 most preferred. The compression ratio chosen may be optimized for the alcohol fuel blend chosen, or vice versa, with the 19.5:1 compression ratio being optimized for neat alcohol fuels, but a lower compression ratio (e.g., 17:1) being more likely optimal for alcohol fuel blends with a lower alcohol content (e.g., between 25%-85%) or f6r higher carbon count alcohol fuels.

The optimum compression ratio strikes a compromise between full spark authority without knock at high load versus the dilute combustion range at light load (i.e., taking into account lower tolerance for EGR dilution at lighter loads). Applicant has found that increasing the compression ratio generally allows for higher efficiency until such point that combustion phasing loss due to retarded spark authority for knock-limited spark timing begins to outweigh the efficiency gains from further increasing the compression ratio, thus resulting in the optimal compression ratio chosen.

As for additional benefits of the foregoing invention, it has been found that light load stability is improved with the engine, as a result of the high compression ratio of the present invention together with the relatively high flame propagation speed of alcohol fuels. Spark-ignited combustion of methanol fuel also produces a slower rate of heat release than for compression ignition of diesel fuel, which reduces heat losses and engine-out NOx emissions.

With regard to alcohol fuel blends that may be used with the invention, the highest thermal efficiency improvements of the internal combustion engine system of the present invention can be obtained using alcohol fuel blends containing alcohols such as ethanol or methanol in quantities greater than about 30% by volume, such as E30, M30, E50, M50, E65, M65, E85, M85, or neat (i.e. greater than 85% alcohol by volume) methanol or ethanol blends. A higher alcohol content generally enables a higher thermal efficiency with the engine system. The preferred fuel for highest thermal efficiency is neat methanol.

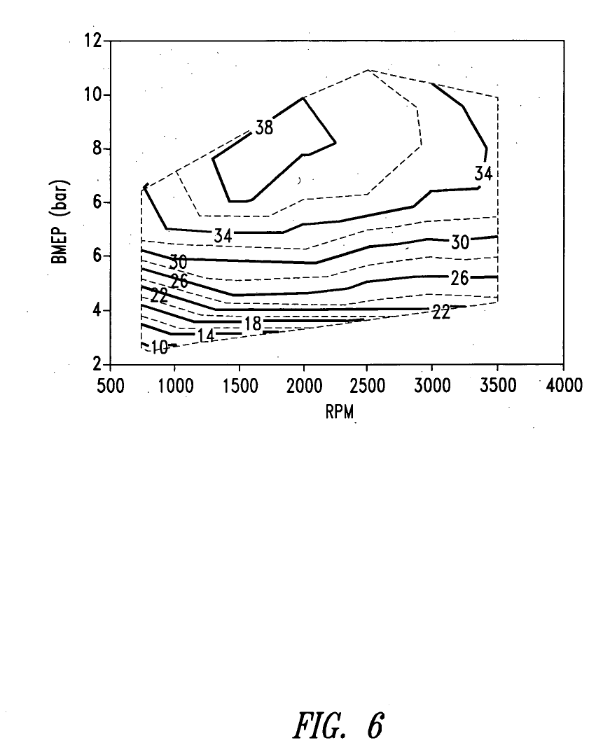

However, the preferred fuels in terms of an overall business case may be E30 and/or M30. This is because, an engine of the present invention adapted to combust E30 or M30 fuel shows a 10-12% increase in efficiency over a comparable gasoline engine, as indicated for example in FIG. 6, which would more than compensate for the approximately 8% less volumetric energy content of that alcohol fuel blend versus conventional gasoline, thus providing the potential for even greater mileage with the alcohol fuel blend than is obtained in a comparable conventional gasoline automobile. As a result, the fuel would meet or outperform gasoline on a per gallon performance basis and would be acceptable for consumers (assuming comparable pricing for the respective fuels) while also, on a global policy level, significantly reducing the global demand for conventional gasoline.

In addition, in consideration of potential supply constraints in the use of ethanol from renewable feedstocks to displace part of the demand for petroleum in transportation, the use of E30 would allow a more readily achievable quantity of ethanol from such feedstocks for widespread use as a long-term market sustainable option than E85. Another benefit of using alcohol fuel blends such as E30 and M30 (or other with alcohol content of about 50% or less) may be in easier handling of cold starts and cold start hydrocarbon emissions compared to a fuel such as E85.

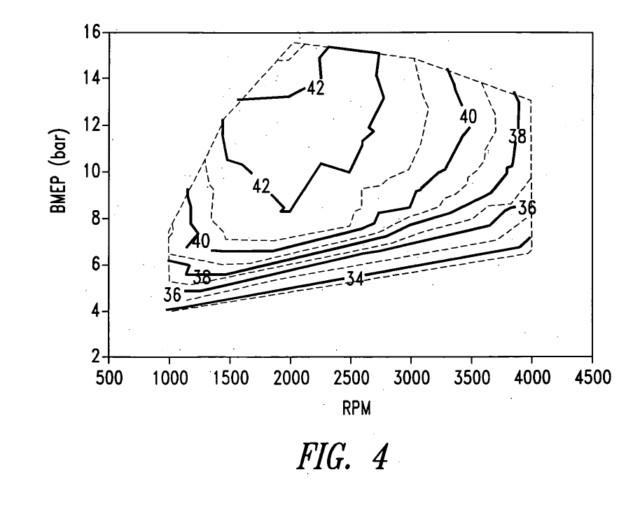

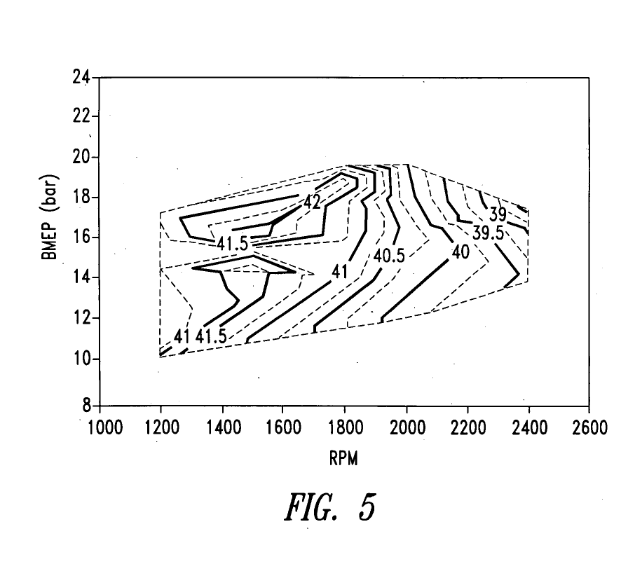

Sample engine efficiency results using the apparatus and methods of the present invention are shown in FIGS. 4 through 6. For example, with neat alcohol fuels, over 40% brake thermal efficiency was achieved over a broad range of engine speeds and loads, with a significant part of the engine map also reaching above 42% efficiency for M100 (methanol having a marginally superior burn rate and octane rating compared to E100) at a compression ratio of 19.5:1, as shown in FIG. 4. In comparison, typical gasoline engines have peak efficiency levels only in the low to mid-30% range. Similar impressive results have been obtained with E85 fuel (which consists of between 70% and 85% ethanol blended with conventional gasoline), as shown in FIG. 5. Efficiency results for the engine using E30 fuel are likewise shown in FIG. 6, showing efficiency levels not as high as for higher alcohol content fuels but still substantially exceeding the efficiency of production gasoline engines.

The high efficiency alcohol fuel engine of the present invention could also be adapted for use in a flex fuel vehicle, in which the engine operation could be adjusted when necessary to also run on conventional gasoline without knocking. This is in contrast to conventional flexible fuel vehicles, which do not take significant advantage of the favorable combustion characteristics of alcohol fuels. For example, the same engine system of the present invention could be used for effective interchangeable combustion of other fuels such as conventional gasoline by provision of a flexfuel sensor (commercially available from suppliers such as Siemens VDO or Magneti Marelli), or potentially a more complex sensor for determining the fuel makeup, octane rating, and vapor pressure, such as disclosed in U.S. Pat. No. 5,225,679 to Clarke, positioned in the vehicle. Alternatively, octane rating of the fuel or fuel makeup could also be determined from one or more sensed or determined combustion characteristics or fuel metering comparisons resulting from the fuel's delivery, combustion characteristics and\or the resulting combustion exhaust products. Each of these sensors and determination methods, and their equivalents, constitute a sensor to “sense characteristics of the fuel,” as the phrase is used in the claims herein.

Sensing of the fuel content could be combined with techniques adapting engine operation of the flex fuel vehicle, such as (i) the use of variable valve timing for a reduction in the effective compression ratio as needed, (ii) direct injection of the fuel to provide a further reduction of T₂, or (iii) reduction of the maximum load through throttling. A variable compression ratio device could also be used to adapt the geometric or effective compression ratio for the fuel being used, as an additional or alternative way to adjust the engine operation to avoid knock in the engine when used with conventional gasoline or other lower octane fuels than alcohol fuels (e.g., octane less than 100). This could be done, for example, with the piston-in-piston variable compression ratio mechanism of commonly-owned U.S. Pat. No. 6,752,105, an ignition piston engine, or other previously considered prior art mechanisms for varying compression ratios in combustion.

The engine system of the present invention would work well in conventional motor vehicle applications, in a hybrid vehicle application to maximize environmental benefits, or in many non-transportation engine applications, and is thus not intended to be limited to a use in motor vehicles or to particular motor vehicles.

It will also be understood that various modifications could be made in the embodiments disclosed herein without departing from the principles of the invention described above. Accordingly, the invention is not limited herein except by the claims.

We claim:

1. An internal combustion engine system, comprising:
an engine block with a plurality of combustion cylinders formed therein, each combustion cylinder being closed at one end by a cylinder head and having a cylinder bore diameter (B);
an intake manifold for receiving charge-air from an intake line and distributing said charge-air to the combustion cylinders;
fuel injectors for providing quantities of an alcohol fuel to mix with the charge-air for combustion;
a controller, for controlling the quantities of alcohol fuel to provide for stoichiometric combustion of the fuel and charge-air mixture;
a piston mounted within each combustion cylinder for reciprocating motion within the combustion cylinder, said piston cycling toward and away from the cylinder head, with a compression ratio of 15:1 or greater, from a bottom dead center position to a top dead center position within the combustion cylinder;
a combustion bowl formed in a head of the piston, said combustion bowl defining walls, along with the cylinder head, of a compact combustion chamber for combustion of the mixture of fuel and charge-air within the combustion cylinder;
a spark plug positioned within a recess in the cylinder head, with a tip extending toward the combustion chamber and in operative communication with the combustion chamber, for triggering combustion of the alcohol fuel and charge-air mixture in the combustion cylinder, wherein the distance (L) between the tip of the spark plug and the farthest point of the compact combustion chamber from that spark plug, when the piston is at the top dead center position, is less than one-half the cylinder bore diameter (B);
an exhaust manifold for receiving and routing exhaust gases from the combustion cylinders to an exhaust line for discharge of the exhaust gas; and
a three-way catalyst aftertreatment device operatively connected to the exhaust line, for reduction of harmful emissions in the exhaust gas.

2. The internal combustion engine system of claim 1, further comprising an exhaust gas recirculation line fluidly connected to the exhaust line, for recirculation of a portion of the exhaust gas to the intake line; and
a valve operatively positioned to control the portion of exhaust gas recirculated in the exhaust gas recirculation line, wherein said valve is operated at times to cause recirculation of greater than 30% of the exhaust gas in the exhaust line.

3. The internal combustion engine system of claim 1, wherein the charge-air distributed to the combustion cylinders is unthrottled for most engine speed and load conditions.

4. The internal combustion engine system of claim 1, further comprising a compressor operatively connected to the intake line for compression of the charge-air to be distributed to the combustion cylinders for combustion.

5. The internal combustion engine system of claim 4, further comprising a cooling device operatively connected to the intake line downstream of the compressor for cooling of the charge-air to be distributed to the combustion cylinders for combustion.

6. The internal combustion engine system of claim 1, wherein the spark plug is positioned at or near the center of the cylinder head.

7. The internal combustion engine system of claim 1, wherein the distance between the tip of the spark plug and the farthest point of the compact combustion chamber from that spark plug, when the piston is at the top dead center position, is about 0.3 times the cylinder bore diameter.

8. The internal combustion engine system of claim 1, wherein the major diameter of the combustion chamber is about 0.45-0.50 times the cylinder bore diameter.

9. The internal combustion engine system of claim 1, wherein the major diameter of the combustion chamber is less than 0.65 times the cylinder bore diameter.

10. The internal combustion engine system of claim 1, wherein the compression ratio is greater than about 16.5:1.

11. The internal combustion engine system of claim 1, wherein the compression ratio is greater than about 19:1.

12. The internal combustion engine system of claim 1, wherein the alcohol fuel provided for combustion comprises an alcohol content by volume of 30% or more.

13. The internal combustion engine system of claim 1, wherein the alcohol fuel provided for combustion comprises a methanol content by volume of 30% or more.

14. The internal combustion engine system of claim 1, wherein the alcohol fuel provided for combustion is E30.

15. The internal combustion engine system of claim 1, wherein the alcohol fuel provided for combustion is E85.

16. The internal combustion engine system of claim 1, wherein the alcohol fuel provided for combustion is neat methanol.

17. The internal combustion engine system of claim 1, wherein the alcohol fuel provided for combustion comprises an alcohol content less than 70% by volume.

18. The internal combustion engine system of claim 1, further comprising insulated intake ports for minimization of heat transfer in the distribution of the charge-air from the intake manifold to the combustion cylinders.

19. The internal combustion engine system of claim 1, wherein the fuel injectors are configured for direct injection of fuel into the combustion cylinders.

20. The internal combustion engine system of claim 1, wherein the fuel injectors are configured for port injection of fuel.

21. The internal combustion engine system of claim 1, wherein direct injection of fuel is used together with port fuel injection.

22. The internal combustion engine system of claim 1, further comprising a sensor to sense characteristics of the fuel to be provided by the fuel injectors.

23. The internal combustion engine system of claim 22, wherein the sensor determines characteristics of the fuel provided by the fuel injectors through comparison of the volume of fuel delivered for stoichiometry in conjunction with the spark advance that reaches the onset of knock limited combustion.

24. The internal combustion engine system of claim 22, adapted for use with a powertrain for a flexible fuel motor vehicle.

25. The internal combustion engine system of claim 24, further comprising variable valve timing of intake valves to the combustion cylinders for a reduction in the effective compression ratio upon sensing characteristics of the fuel indicative of a reduced alcohol content of the fuel.

26. The internal combustion engine system of claim 1, further comprising a variable compression ratio device operatively positioned with respect to the combustion cylinder in order to adapt the compression ratio for the fuel being used within the internal combustion engine.

27. A method of operation for a flexible fuel motor vehicle comprising a vehicle frame, drive wheels rotatably mounted on the vehicle frame, and a fuel tank, internal combustion engine, and drivetrain further mounted on the vehicle frame for transmission of power to the drive wheels for propulsion of the motor vehicle, said method of operation comprising:
determining an octane rating or alcohol content of fuel carried in the fuel tank;
operating the internal combustion engine at a compression ratio greater than 15:1;
adjusting the engine operation or compression ratio to avoid knock when the fuel is not an alcohol fuel, or when the determined octane rating for the fuel is less than 100.

28. A method of controlling engine operation in a motor vehicle, comprising:
determining the position of an accelerator pedal for the motor vehicle,
determining a desired change in engine load corresponding to the accelerator pedal position,
determining a desired change in exhaust gas recirculation levels, or in levels of compression of a charge-air mixture, such as to obtain a desired charge-air oxygen mass for unthrottled, stoichiometric combustion at the desired engine load of an alcohol fuel stored in the vehicle for combustion,
taking the desired charge-air oxygen mass into the engine,
injecting the alcohol fuel into the engine for combustion in a quantity selected to obtain the desired change in engine load and to maintain stoichiometric combustion of the fuel.
